(19) United States
(12) Patent Application Publication
(10) Pub. No.: US 2025/0226506 A1
(43) Pub. Date: Jul. 10, 2025

(54) BATTERY PACK

(71) Applicant: TOYOTA JIDOSHA KABUSHIKI KAISHA, Toyota-shi Aichi-ken (JP)

(72) Inventors: Shinya GOITSUKA, Nisshin-shi Aichi-ken (JP); Shigeyuki INOUE, Toyota-shi Aichi-ken (JP)

(73) Assignee: TOYOTA JIDOSHA KABUSHIKI KAISHA, Toyota-shi Aichi-ken (JP)

(21) Appl. No.: 19/013,063

(22) Filed: Jan. 8, 2025

(30) Foreign Application Priority Data
Jan. 10, 2024 (JP) 2024-001646

(51) Int. Cl. H01M 50/242; B60L 50/64; H01M 50/204; H01M 50/249; H01M 50/262

(52) U.S. Cl. CPC H01M 50/242; B60L 50/64; H01M 50/204; H01M 50/249; H01M 50/262; H01M 2220/20

(57) ABSTRACT

A battery pack adapted to suppress the possibility that a crash stroke cannot be ensured. The battery pack according to the present disclosure is mounted on a vehicle. The battery pack includes a storage case, a plurality of first cross members extending in a width direction of the vehicle, a second cross member extending in a longitudinal direction of the vehicle, a battery module, and a bracket. The battery module, the second cross member, and the bracket are arranged between the plurality of the first cross members, and the second cross member is arranged at a position separated from the battery module in a width direction of the vehicle. The bracket is arranged between the second cross member and the battery module. The battery module is attached to the storage case via the bracket. The bracket includes a bead protruding outward in a width direction of the vehicle.

### CROSS REFERENCE TO RELATED APPLICATIONS

This application is based upon and claims the benefit of priority from Japanese patent application No. 2024-001646, filed on Jan. 10, 2024, the disclosure of which is incorporated herein in its entirety by reference.

### BACKGROUND

The present disclosure relates to a battery pack.

The mounting structure of a battery pack disclosed in Patent Literature 1 includes a bus bar and a shock absorber. The bus bar is housed inside a storage case, and a shock absorber is arranged outside the storage case. The shock absorber is arranged so that when the shock absorber is projected horizontally in the direction of the battery pack, the projected image of the shock absorber formed by the projection does not overlap the bus bar. The mounting bracket mounts a plurality of battery stacks to the storage case. The reinforcing bracket reinforces the mounting of the battery stacks to the bottom or peripheral wall of the storage case.

Patent Literature 1: Japanese Unexamined Patent Application Publication No. 2023-046719

### SUMMARY

The present inventors have found the following technical problems.

In a mounting structure of the aforementioned battery pack, the battery pack may receive an impact from the side thereof. In such a case, a shock absorber collapses and is displaced toward the battery stack side, and a load may be applied on the peripheral wall of the storage case or the reinforcing bracket. The storage case and the reinforcing bracket may be deformed due to reception of the load. However, the storage case and the reinforcing bracket have different functions other than ensuring a crash stroke, and they may hardly contribute to a crash stroke in a battery pack. Therefore, there was a fear that a crash stroke could not be ensured.

The present disclosure has been made in view of the above-described problem, and it is an object of the present disclosure to provide a battery pack capable of suppressing the possibility that a crash stroke cannot be ensured.

According to the present disclosure, a battery pack mounted on a vehicle, includes:
a storage case;
a plurality of first cross members extending in a width direction of the vehicle;
a second cross member extending in a longitudinal direction of the vehicle;
a battery module; and
a bracket, in which
the battery module, the second cross member, and the bracket are arranged between the plurality of the first cross members,
the second cross member is arranged at a position separated from the battery module in a width direction of the vehicle,
the bracket is arranged between the second cross member and the battery module,
the battery module is attached to the storage case via the bracket,
the bracket includes a bead protruding outward in a width direction of the vehicle,
the second cross member includes a bead protruding inward in the width direction of the vehicle, and
the bead of the bracket and the bead of the second cross member are arranged oppositely to and spaced apart from a central point between the plurality of the first cross members.

In the battery pack described above, the bracket includes a recessed part recessed in the width direction of the vehicle, and the recessed part of the bracket may be arranged at the central point between the plurality of the first cross members of the bracket.

In the battery pack described above, the second cross member comprises a recessed part recessed in the width direction of the vehicle, and the recessed part of the second cross member is arranged at the central point between the plurality of the first cross members of the second cross member.

According to the present disclosure, it is possible to suppress the possibility that a crash stroke cannot be ensured.

The above and other objects, features and advantages of the present disclosure will become more fully understood from the detailed description given hereinbelow and the accompanying drawings.

### BRIEF DESCRIPTION OF DRAWINGS

FIG. 1 is a top view of a battery pack according to the present disclosure;

FIG. 2 is an enlarged top view of a part of the battery pack according to the present disclosure; and

FIG. 3 is an enlarged perspective view of a part of the battery pack according to the present disclosure.

### DESCRIPTION OF EMBODIMENTS

Hereinafter, specific embodiments to which present disclosure is applied will be described in detail with reference to the drawings. However, present disclosure is not limited to the following embodiments. For clarity of explanation, the following description and drawings have been simplified as appropriate.

### First Embodiment

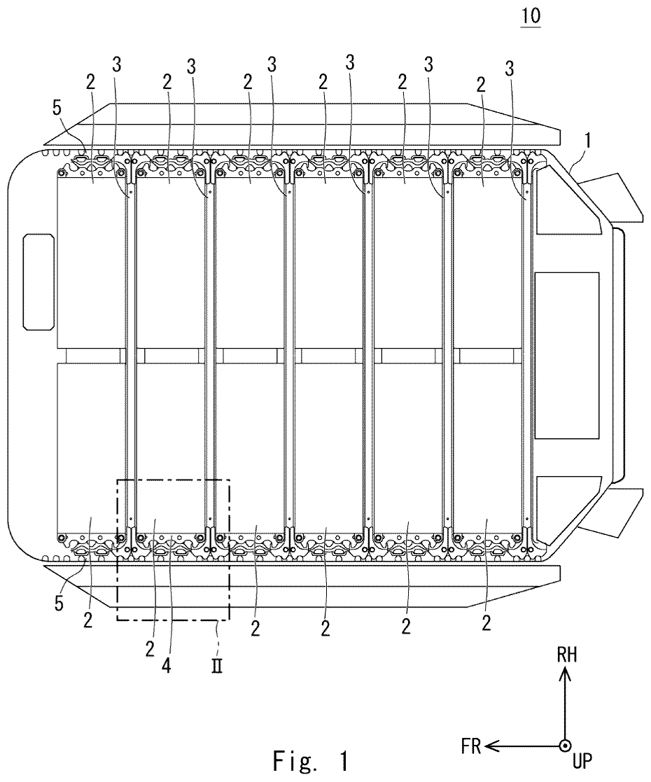

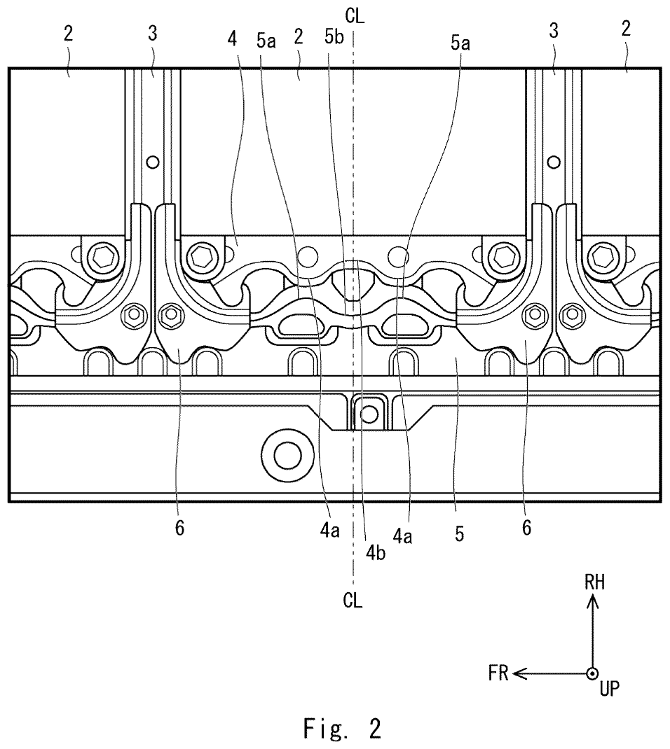

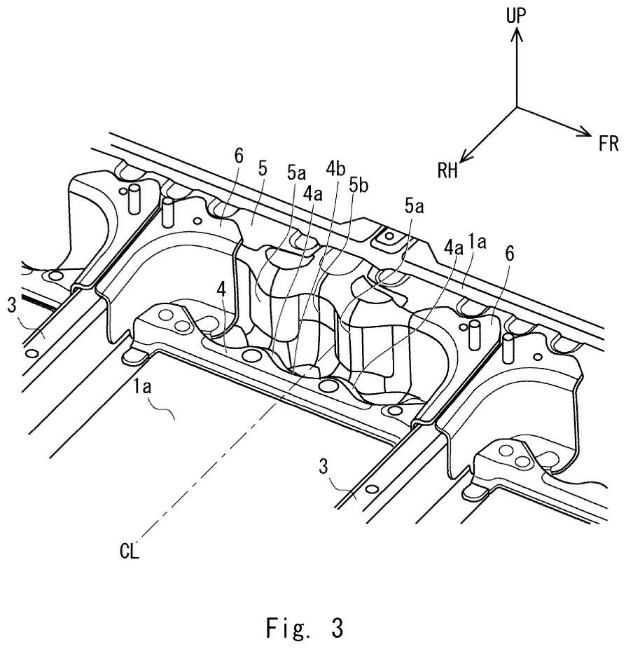

A first embodiment will be described with reference to FIGS. 1 to 3. FIG. 1 is a top view of a battery pack according to the present disclosure. FIG. 2 is an enlarged top view of a part (part II) of the battery pack shown in FIG. 1. FIG. 3 is an enlarged perspective view of a part of the battery pack shown in FIG. 1. In FIG. 3, illustration of a battery module 2 is omitted.

It should be noted that the three-dimensional coordinates shown in FIG. 1 and other drawings are for the sake of convenience in explaining the positional relationship of the components. In general, in the drawings, the UP-axis positive direction is the upward direction of the vehicle (not shown), the FR-axis positive direction is the front side of the vehicle, and the RH-axis positive direction is the right side of the vehicle. The FR-axis extends in the longitudinal direction of the vehicle, and the RH-axis extends in the width direction of the vehicle.

As shown in FIG. 1, a battery pack 10 includes a storage case 1, a battery module 2, a plurality of first cross members 3, a bracket 4, and a second cross member 5. The battery pack 10 is mounted on a vehicle (not shown). Examples of such vehicle include a HEV (Hybrid Electric Vehicle), a PHEV (Plug-in Hybrid Electric Vehicle), a FCEV (Fuel Cell Electric Vehicle), a BEV (Battery Electric Vehicle), and the like. The battery pack 10 may include a plurality of the battery modules 2, the brackets 4, and the second cross members 5.

The storage case 1 houses the battery module 2, a plurality of the first cross members 3, the bracket 4, and the second cross member 5.

The battery module 2, a plurality of the first cross members 3, the bracket 4, and the second cross member 5 are arranged on a bottom surface 1a of the storage case 1 shown in FIG. 3. The battery module 2, the second cross member 5, and the bracket 4 are arranged between a plurality of the first cross members 3. The battery module 2 is, for example, a lithium-ion battery or the like.

The plurality of first cross members 3 extend in the width direction of the vehicle. In an example shown in FIGS. 1 and 2, the plurality of the first cross members 3 extend in the RH-axis direction. The second cross member 5 extends in the width direction of the vehicle. In an example shown in FIGS. 1 and 2, the second cross member 5 extends in the FR-axis direction. The second cross member 5 is arranged at a position separated from the battery module 2 in the width direction of the vehicle. The plurality of the first cross members 3 and the second cross member 5 are mechanically connected. In some embodiments, the plurality of first cross members 3 are mechanically connected to the second cross member 5 via a member 6. In some embodiments, the plurality of the first cross members 3 and the plurality of the second cross members 5 mechanically connected in this way to form a ladder-like body.

As shown in FIG. 2, the bracket 4 is arranged between the second cross member 5 and the battery module 2. The battery module 2 is attached to the bottom surface 1a of the storage case 1 shown in FIG. 3 via the bracket 4. The bracket 4 includes a bead 4a protruding outward in the width direction of the vehicle. In the example shown in FIGS. 2 and 3, the bead 4a projects in the RH-axis negative direction.

The second cross member 5 extends in the longitudinal direction of the vehicle. The second cross member 5 is arranged at a position separated from the battery module 2 in the width direction of the vehicle. The second cross member 5 includes a bead 5a which projects inward in the width direction of the vehicle. In the example shown in FIGS. 2 and 3, the bead 5a projects in the RH-axis positive direction.

The bead 4a of the bracket 4 and the bead 5a of the second cross member 5 are arranged oppositely to each other. The bead 4a of the bracket 4 and the bead 5a of the second cross member 5 are spaced apart from the central point between the plurality of the first cross members 3.

The bracket 4 includes a recessed part 4b recessed in the width direction of the vehicle. The recessed part 4b is arranged at the center point between the plurality of the first cross members 3 in the bracket 4. In the example shown in FIGS. 2 and 3, the recessed part 4b is arranged on the center line CL extending through the center point between the plurality of the first cross members 3.

The second cross member 5 includes a recessed part 5b recessed in the width direction of the vehicle. The recessed part 5b is arranged at the center point between the plurality of the first cross members 3 of the second cross member 5. In an example shown in FIGS. 2 and 3, the recessed part 5b is arranged on the center line CL.

Here, the battery pack 10 is mounted on the vehicle, and the battery pack 10 receives an impact (i.e., shock) from the side thereof. Then, the second cross member 5 receives a load and distributes the load to the plurality of the first cross members 3. The second cross member 5 bends toward the battery module 2. The bead 5a of the second cross member 5 abuts against the bead 4a of the bracket 4. The bead 5a and the bead 4a are compressed and deformed in the width direction of the vehicle. The battery pack 10 can ensure a crash stroke for the length of the bead 5a and the bead 4a in the width direction of the vehicle. Accordingly, a certain crash stroke can be imparted to the battery pack 10. That is, it is possible to suppress the possibility that a crash stroke cannot be ensured.

The load received by the second cross member 5 tends to be largest at the center between the plurality of first cross members 3 of the second cross member 5. The bracket 4 according to the present embodiment includes the recessed part 4b recessed in width direction of the vehicle. The recessed part 4b is arranged at the center between the plurality of first cross members 3 in the bracket 4. Thus, a gap between the bracket 4 and the second cross member 5 can be secured at the center point between the plurality of the first cross members 3 of the second cross member 5 where the load received by the second cross member 5 is apt to be largest. Thus, it is possible to contribute to ensuring a stable crash stroke.

Also, the second cross member 5 according to this embodiment includes the recessed part 5b recessed in width direction of the vehicle. The recessed part 5b is arranged at the center point between the plurality of the first cross members 3 of the second cross member 5. Thus, the gap between the bracket 4 and the second cross member 5 can be secured at the center point between the plurality of the first cross members 3 of the second cross member 5, where the load received by the second cross member 5 is apt to be the largest. Thus, it is possible to contribute to ensuring a stable crash stroke.

It should be noted that present disclosure is not limited to the above embodiments and may be changed as appropriate to the extent that it does not deviate from the gist of the present disclosure. Further, the present disclosure may be implemented by combining the aforementioned embodiments or one of the examples thereof as appropriate.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack mounted on a vehicle, comprising:
a storage case;
a plurality of first cross members extending in a width direction of the vehicle;
a second cross member extending in a longitudinal direction of the vehicle;
a battery module; and
a bracket, wherein
the battery module, the second cross member, and the bracket are arranged between the plurality of the first cross members,
the second cross member is arranged at a position separated from the battery module in a width direction of the vehicle,
the bracket is arranged between the second cross member and the battery module,
the battery module is attached to the storage case via the bracket,
the bracket includes a bead protruding outward in a width direction of the vehicle,
the second cross member includes a bead protruding inward in the width direction of the vehicle, and
the bead of the bracket and the bead of the second cross member are arranged oppositely to and spaced apart from a central point between the plurality of the first cross members.

2. The battery pack according to claim 1, wherein
the bracket includes a recessed part recessed in the width direction of the vehicle, and
the recessed part of the bracket is arranged at the central point between the plurality of the first cross members of the bracket.

3. The battery pack according to claim 1, wherein
the second cross member comprises a recessed part recessed in the width direction of the vehicle, and
the recessed part of the second cross member is arranged at the central point between the plurality of the first cross members of the second cross member.
